(19) United States
(12) Patent Application Publication
(10) Pub. No.: US 2019/0322487 A1
(43) Pub. Date: Oct. 24, 2019

(54) METHOD AND ARRANGEMENT FOR MONITORING AT LEAST ONE ROPE IN AN ELEVATOR

(71) Applicant: KONE Corporation, Helsinki (FI)

(72) Inventor: Petteri VALJUS, Helsinki (FI)

(73) Assignee: KONE Corporation, Helsinki (FI)

(21) Appl. No.: 16/453,024

(22) Filed: Jun. 26, 2019

Related U.S. Application Data
(63) Continuation of application No. PCT/FI2018/050133, filed on Feb. 23, 2018.

(30) Foreign Application Priority Data
Mar. 3, 2017 (FI) 20175198

(51) Int. Cl. B66B 7/12; B66B 5/00

(52) U.S. Cl. CPC B66B 7/123; B66B 5/0018; B66B 7/1261; B66B 7/1223

(57) ABSTRACT

A method includes transmitting electromagnetic radiation towards a rope with a transmitter, receiving electromagnetic radiation reflected or emitted from the rope with a detector, performing a mathematical transformation of the output signal of the detector with a processing unit for decomposing the output signal into the frequencies that make it up, and determining the wavelengths of the electromagnetic radiation that have been absorbed by at least one substance on the rope and the amount of the absorption of said wavelengths in order to determine the amount and the content of the substance on the rope.

### FIELD OF THE INVENTION

The invention relates to a method and an arrangement for monitoring at least one rope in an elevator.

### BACKGROUND ART

An elevator may comprise a car, an elevator shaft, lifting machinery, ropes, and a counter weight. The elevator car may be positioned within a car frame, whereby the car frame may be integrated into the car structures or formed as a separate frame. The lifting machinery may be positioned in the shaft or in a machine room. The lifting machinery may comprise a drive, an electric motor, a traction sheave, and a machinery brake. The lifting machinery may move the car in a vertical direction upwards and downwards in the vertically extending elevator shaft. The ropes may connect the car frame via the traction sheave to the counter weight. The car frame may further be supported with glide means on car guide rails extending along the height of the shaft. The glide means may engage with the car guide rails and keep the car in position in the horizontal plane when the car moves upwards and downwards in the elevator shaft. The counter weight may be supported in a corresponding way on counter weight guide rails supported on the wall structure of the shaft. The car may transport people and/or goods between the landings in the building. The shaft may be formed so that the wall structure is formed of solid walls or so that the wall structure is formed of an open steel structure. A speed governor may further be used as a safety device. The overspeed governor may be supported with a rope in the shaft.

The monitoring of the condition of ropes in an elevator is today based mainly on visual observation by the maintenance technician. The inspection requires time, competence and comparison to predetermined discharging criterion. Items to be inspected are e.g. 1) The condition of the lubrication of the rope, 2) Possible foreign particles e.g. dust on the surface of the rope which may be a result of internal wear of the rope or of wear caused by the groove in the traction sheave in a situation when the rope is starving, 3) The amount of wire cuts in the strands of the rope, 4) The size of wear lenses of the wires of the rope, 5) The reduction in the rope diameter, 6) The outlook and the stability of the rope construction, e.g. loose strands, cork screw, birdcage, etc.

The evaluation of the condition of the ropes requires much experience in order to be reliable. The evaluation becomes thus subjective and evaluations made by different technicians may differ. It would thus be a benefit to have a reliable and fast method for monitoring at least one rope in an elevator. There is especially a need for determining the presence of at least one substance on the rope. The at least one substance of interest on the rope may be e.g. the lubrication on the rope and/or dirt on the rope and/or rust on the rope or any combination of these.

### BRIEF DESCRIPTION OF THE INVENTION

An object of the present invention is to present a novel method and arrangement for monitoring at last one rope in an elevator.

The method for monitoring at least one rope in an elevator according to the invention is defined in claim 1.

The arrangement for monitoring at least one rope in an elevator according to the invention is defined in claim 6.

The method for monitoring at least one rope in an elevator comprises:

transmitting electromagnetic radiation towards the rope with a transmitter positioned in the vicinity of the rope,

receiving electromagnetic radiation reflected or emitted from the rope with a detector positioned in the vicinity of the rope,

performing a mathematical transformation of the output signal of the detector with a processing unit for decomposing the output signal into the frequencies that make it up,

determining the wavelengths of the electromagnetic radiation that have been absorbed by at least one substance on the rope and the amount of the absorption of said wavelengths in order to determine the amount and the content of the substance on the rope.

The arrangement for monitoring at least one rope in an elevator comprises:

a transmitter positioned in the vicinity of the rope, said transmitter transmitting electromagnetic radiation towards the rope,

a detector positioned in the vicinity of the rope, said detector receiving electromagnetic radiation reflected or emitted from the rope,

a processing unit for performing a mathematical transformation of the output signal of the detector for decomposing the output signal into the frequencies that make it up, whereby

the wavelengths of the electromagnetic radiation that have been absorbed by at least one substance on the rope and the amount of the absorption of said wavelengths can be determined in order to determine the amount and the content of the substance on the rope.

The monitoring of the at least one rope is based on transmitting electromagnetic radiation with a transmitter towards the rope and receiving to reflected or emitted electromagnetic radiation with a detector from the rope.

The analysis of the at least one substance on the at least one rope is based on a mathematical transformation of the output signal of the detector. The mathematical transformation transforms the time domain of the measured signal into a different domain. The mathematical transformation transforms decomposes the output signal of the detector into the frequencies that make it up. The transformed signal is then analysed in order to detect absorbed wavelengths, whereby the amount and the content of the substances on the rope can be determined.

One possibility to analyse the at least one substance on the at least one rope is to use Fourier transform infrared (FTIR) spectroscopy. The Fourier transform decomposes a function of time (a signal) into the frequencies that make it up. FTIR spectroscopy is a technique which is used to obtain a spectrum of electromagnetic radiation absorbed or emitted of a solid, liquid or gas. An FTIR spectrometer simultaneously collects high spectral resolution data over a wide spectral range of electromagnetic radiation. The absorption of electromagnetic radiation in the sample can be determined based on the spectrum of electromagnetic radiation passing through the sample or based on the spectrum of the electromagnetic radiation reflected from the sample. When exposed to electromagnetic radiation, molecules and chains of molecules in a material absorb electromagnetic radiation at specific wavelengths. Different molecules and different chains of molecules produce different patterns or wavelengths, whereby the pattern form a kind of a fingerprint of the molecule or chains of molecules. By directing electromagnetic radiation with a transmitter towards a sample and by detecting the spectrum of electromagnetic radiation passing through the sample or reflected from the sample with a detector it is possible to identify the molecules in the sample.

It is thus possible to monitor the amount and the content of the at least one substance on a rope with FTIR spectroscopy. The electromagnetic radiation received by the detector is analysed with fast Fourier transformation. This processing creates an XY-graph where the Y-axis shows the amplitude of the molecules in the sample to be analysed. The amplitude is a function of the quantity of the molecules or molecule chains present in the sample to be analysed. The location of the peaks along the X-axis indicate the weight of the molecules.

Any substance on the rope may be monitored with the method. The substance may be e.g. a lubricant on the rope, dirt on the rope, rust on the rope or any combination of these.

Each lubricant has a pre-defined compound of ingredients e.g. organic or synthetic greases and compounds. The peaks of a new factory lubricated rope can be recorded beforehand or just when a new elevator is put in operation. When the rope starts to dry, the amplitudes of the characteristic peaks start to reduce. If the surface of the rope becomes dirty, new peaks will appear in the XY-graph, but they will have different frequencies. This method makes it possible to monitor the condition of the lubrication of the rope. This monitoring may include monitoring those parameters of the lubricant that predict the condition of the lubrication. Such parameters are e.g. the amount of lubricant on the rope, the amount of impurities e.g. metal powder in the lubricant, the presence of rust in the lubricant, the aging of the lubricant, the oxidation of the lubricant, the water content in the lubricant etc.

A re-lubricant that is to be used for re-lubricating the rope may be analysed with FTIR beforehand and the characteristics may be stored in the software. The re-lubrication of the rope can thus be detected and the peaks in the XY-graph received during the measurement of the re-lubricant may be used as a reference level for the subsequent measurements.

It is thus possible to easily create discharging criterion based on the reduction in the amplitudes in the XY-graph and/or based on absent peaks in the XY-graph by measuring a starving rope which requires immediate re-lubrication.

It is also possible to add a marker which is sensitive to the electromagnetic radiation transmitted with the transmitter to the lubricant on the rope. The presence of the marker in the lubricant may be detected with the detector. The use of the marker in the lubricant would make it easy to identify the lubricant in the analysis and the amount of the lubricant on the rope. The marker should be sensitive only to a narrow wavelength range of the used electromagnetic radiation so that the presence of the marker in the lubricant is easy to detect.

It is possible to monitor the condition of ropes on-line with the invention. A test procedure of the ropes may be performed e.g. once a week with the invention. The elevator may be run in a test cycle during the measurements. The results of the measurements may be used as base information when planning preventive maintenance visits to the elevator site. The results of the test runs may be transferred e.g. to a cloud service, whereby the results are available to authorized persons from said cloud service all over the world.

The type of problem on the rope can thus be monitored on-line with the invention. An appropriate service measure to be undertaken on the rope may then be selected based on the type of problem on the rope. A change of the spectrum of the lubricant on the rope to a spectrum indicating rust and/or water on the rope means that the lubrication of the rope is weakened. This information may then be transferred e.g. via a cloud service to a service centre as a maintenance information. This maintenance information may then result in an adjustment of the maintenance schedule for the rope and/or in issuance of an alarm and/or in issuance of an out of service command. The measurement may be amplified with a marker added into the lubricant. The invention makes it possible to detect the use of a false lubricant immediately, whereby an alarm and/or an out of service command could be issued immediately. The identification of a false lubricant may be amplified with a marker added to the correct lubricant. The lack of the marker in the measured spectrum will thus immediately indicate that a false lubricant is used.

The electromagnetic radiation transmitted by the transmitter may have a wavelength in the order of 100 nm to 25 μm, advantageously in the range of 1 μm to 25 μm, more advantageously in the range of 3,125 to 8,333 μm.

The wavelength range to be used may be determined based on the substances to be analysed on the ropes i.e. based on the molecules and molecule chains to be detected in the substances. The wavelength range of the electromagnetic radiation may be selected so that the electromagnetic radiation that is absorbed into the substances excites the molecules or the molecule chains in the substances. The wavelength range of the electromagnetic radiation may, in case the substance to be analysed is a lubricant on the rope, be selected so that the electromagnetic radiation that is absorbed into the lubricant excites the molecules or the molecule chains in the organic or synthetic greases and compounds in the lubricant.

The wavelengths of the electromagnetic radiation that perform this excitation are missing in the reflected electromagnetic radiation.

The transmitter may comprise at least one radiation source. A radiation source produces a specific wavelength spectrum. It might be necessary to use several radiation sources in order to broaden the wavelength spectrum that can be produced with the transmitter. The different substances to be monitored on the ropes may absorb wavelengths that are far away from each other making it necessary to use several radiation sources in the transmitter.

The wavelength of visible electromagnetic radiation is in the range of 380 to 750 nm, the wavelength of near IR electromagnetic radiation is in the range of 750 nm to 2.5 μm, the wavelength of mid IR electromagnetic radiation is in the range of 2.5 to 10 μm and the wavelength of far IR radiation is in the range of 10 μm to 1 mm.

### BRIEF DESCRIPTION OF THE DRAWINGS

The invention will in the following be described in greater detail by means of preferred embodiments with reference to the attached drawings, in which

FIG. 1 shows a vertical cross sectional view of an elevator,

FIG. 2 shows a first embodiment of the invention,

FIG. 3 shows a second embodiment of the invention,

FIG. 4 shows a spectrum of a lubricant,

FIG. 5 shows the total spectrum of rope grease.

### DETAILED DESCRIPTION OF EMBODIMENTS OF THE INVENTION

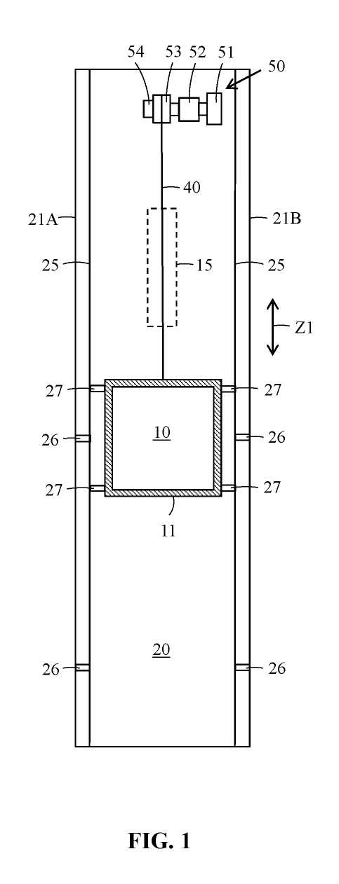

FIG. 1 shows a vertical cross sectional view of an elevator.

The elevator comprises a car 10, an elevator shaft 20, lifting machinery 50, ropes 40, and a counter weight 15. A separate or an integrated car frame 11 may surround the car 10.

The lifting machinery 50 may comprise a drive 51, an electric motor 52, a traction sheave 53, and a machinery brake 54. The lifting machinery 50 moves the car 10 in a vertical first direction Z1 upwards and downwards in the vertically extending elevator shaft 20. The machinery brake 54 stops the rotation of the traction sheave 53 and thereby the movement of the elevator car 10. The lifting machinery 50 may be positioned in the shaft 20 or in a separate machine room.

The car frame 11 may be connected by the ropes 40 via the traction sheave 53 to the counter weight 15. The car frame 11 may further be supported with glide means 27 on car guide rails 25 extending in the vertical direction in the shaft 20. The glide means 27 may comprise rolls rolling on the car guide rails 25 or gliding shoes gliding on the car guide rails 25 when the car 10 is moving upwards and downwards in the elevator shaft 20. The car guide rails 25 may be attached with fastening brackets 26 to the side wall structures 21 in the elevator shaft 20. The glide means 27 keep the car frame 11 and thereby also the car 10 in position in the horizontal plane when the car 10 moves upwards and downwards in the elevator shaft 20. The counter weight 15 may be supported in a corresponding way on counter weight guide rails that are attached to the wall structure 21A, 21B of the shaft 20.

The car 10 transports people and/or goods between the landings in the building. The elevator shaft 20 can be formed so that the wall structure 21A, 21B is formed of solid walls or so that the wall structure 21A, 21B is formed of an open steel structure.

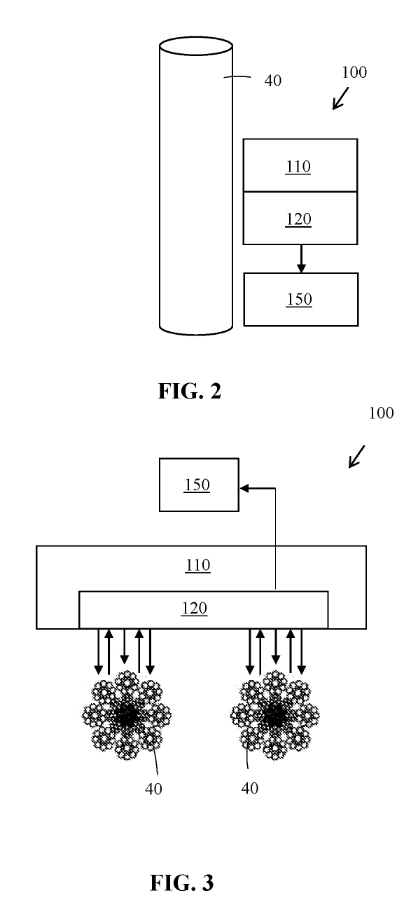

FIG. 2 shows a first embodiment of the invention. The figure is a side view.

The figure shows a rope 40 and a measurement apparatus 100 in the vicinity of the rope 40. The measurement apparatus 100 may comprise a transmitter 110 transmitting electromagnetic radiation e.g. infrared (IR) radiation towards the rope 40 and a detector 120 detecting the electromagnetic radiation that is reflected or emitted from the rope 40. The output signal of the detector 120 may be sent to a processing unit 150 where a mathematical transformation is performed to the output signal of the detector. The transformed signal is then analysed in order to determine wavelengths that have been absorbed to the at least one substance on the rope.

The transmitter 110 may comprise at least one radiation source producing electromagnetic radiation within a desired wavelength range. One possibility is to use an FTIR spectrometer. FTIR spectrometers are usually used for measurements in the mid IR region of electromagnetic radiation i.e. in the wavelength range of 2 to 25 μm and in the near IR regions of electromagnetic radiation i.e. in the wavelength range of 1 to 2 μm. A common radiation source in the mid-IR region is a silicon carbide element heated to about 1200 K. The output is similar to a blackbody. A tungsten-halogen lamp having a higher temperature may be used as the radiation source in the near-IR region. The wavelength spectrum of the electromagnetic radiation produced with the transmitter 110 may be widened by using several radiation sources. The wavelength spectrums of the radiation sources could then be partly overlapping.

The electromagnetic radiation is directed in the transmitter 110 through an aperture controlling the amount to be presented to the sample. Next, the beam enters the interferometer in the transmitter 110 where it is “encoded” using a series of stationary and movable mirrors. This encoding is a way to produce a signal that consists of all the important infrared frequencies simultaneously. The beam then enters the sample, and certain frequencies of the energy are absorbed by the molecules in the sample.

The electromagnetic radiation that is reflected from the sample is directed to the detector 120 where it is measured. This measured signal is then sent to the processing unit 150 where Fourier transformation takes place. Fourier transformation is a mathematical process where a waveform can be broken into an alternate representation for easy viewing. The results of the Fourier analyses may be plotted on a screen connected to the processing unit 150 for visual analyses or the results may be analysed automatically by a computer program within the processing unit 150. The computer program may then as a result of the analyses trigger a warning signal within a control centre indicating need of service of the at least one rope 40. Also other similar mathematical transformation methods may be used instead of Fourier transformation.

The detector 120 may be a pyroelectric detector 120 that responds to changes in temperature as the intensity of electromagnetic radiation falling on the detector 120 varies. The sensitive elements in the detector 120 may be e.g. deuterated triglycine sulfate (DTGS) or lithium tantalate (LiTaO3). These detectors operate at ambient temperatures and provide adequate sensitivity for most routine applications. To achieve the best sensitivity the time for a scan is typically a few seconds. Cooled photoelectric detectors are employed for situations requiring higher sensitivity or faster response. Liquid nitrogen cooled mercury cadmium telluride (MCT) detectors are the most widely used in the mid-IR range. With these detectors an interferogram can be measured in as little as 10 milliseconds.

There are commercially available FTIR apparatuses comprising the transmitter 110 and the detector 120. The detector 120 may be connected to a smart mobile phone provided with a program for performing the FTIR analysis of the measurement results. Such an apparatus may be used as a mobile FTIR apparatus by a technician performing maintenance and monitoring of the ropes.

FIG. 3 shows a second embodiment of the invention. The figure is a horizontal cross sectional view.

The figure shows two parallel ropes 40 at a distance from each other and a measurement apparatus 100 in the vicinity of the ropes 40. The measurement apparatus 100 comprises a transmitter 110 transmitting a horizontal curtain of electromagnetic radiation towards the ropes 40. A detector 120 detects the electromagnetic radiation that is reflected or transmitted from the surface of the first rope 40. The electromagnetic radiation will not penetrate into the ropes 40, but can pass freely past the ropes 40 on both sides of the ropes 40. A reflector 130 may be positioned on the opposite side of the ropes 40 reflecting back the portion of electromagnetic radiation that passes on the sides of the ropes 40. The reflected electromagnetic radiation may be measured with an additional detector 140. The detector 120 and the additional detector 140 may both be connected to a processing unit 150. The processing unit 150 may perform the calculations needed for the analysis of the at least one substance on the ropes. The processing unit 150 may be provided with a screen in order to visualize the results.

The transmitter 110 may comprise at least one radiation source producing the spectrum of electromagnetic radiation that is needed. One radiation source may be enough if the spectrum of electromagnetic radiation is wide enough. The sensitive wavelengths of the substances to be analysed on the ropes may be far away from each other, whereby two or more radiation sources may be needed in order to produce the required spectrum of wavelengths. The sensitive wavelengths are the wavelengths which the substance absorbs from the electromagnetic radiation.

The additional detector 140 may be a Charge Coupled Device (CCD), which is a highly sensitive photon detector. The CCD is divided up into a large number of light-sensitive small areas i.e. pixels which can be used to build up an image of the scene of interest. A photon of light which falls within the area defined by one of the pixels will be converted into one or more electrons and the number of electrons collected will be directly proportional to the intensity of the scene at each pixel. CODs can have a wide wavelength range ranging from about 400 nm (blue) to about 1050 nm (Infra-red) with a peak sensitivity at around 700 nm.

The pixels in the additional detector 140 are able to detect the reflected or emitted electromagnetic radiation. The shadow of the rope 40 is to thus projected on the additional detector 140 i.e. the transmitted radiation cannot pass through the rope 40. The diameter of the ropes 40 can thus be determined based on the pixels that receive electromagnetic radiation transmitted by the transmitter 110. The detector 120 may correspond to the detector 120 in the arrangement in FIG. 2.

It is thus possible to measure the outer diameter of the rope 40 with the electromagnetic radiation. The width of the electromagnetic radiation produced by the transmitter 110 may be adapted according to the needs. The width of the electromagnetic radiation may cover only one rope 40 or several ropes 40 at a time.

It may be possible to substitute the detector 120 and the additional detector 140 with only one detector performing all the tasks of the detector 120 and the additional detector 140. The reflector 130 might also not be needed. It is possible to use a detector 120 that is able to outline the boarders of the rope 40. A distance measurement method based on interference may be used, whereby it is possible to identify at which point the electromagnetic radiation passes on the side of the rope 40 without the reflector 130.

There might on the other hand be a need for several radiation sources in the transmitter 110. One or several radiation sources in a first set of radiation sources could provide the electromagnetic radiation needed for the analysis of the at least one substance on the ropes 40. One or several radiation sources in a second set of radiation sources could on the other hand provide the electromagnetic radiation needed for the analysis of the rope i.e. the diameter, loose strands, broken strands etc. of the rope.

There could be any number of detectors 120, 140 positioned in any pattern in the vicinity of the at least one rope 40.

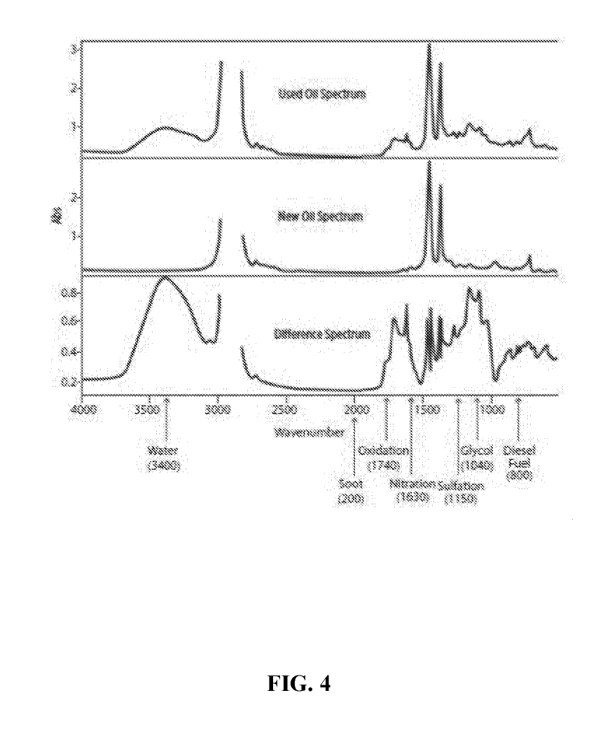

FIG. 4 shows an example of an FTIR analysis graph of a lubricant.

The graph shows the spectrum of used oil, the spectrum of new oil and the difference spectrum. The difference spectrum shows that the used oil contains water, that there is oxidation, nitration, sulfation and that the oil further contains e.g. soot, glycol and diesel fuel. The graph shows the principal of the result of FTIR analysis and is applicable also to lubricants used in ropes. A lubricant used in a rope may contain at least grease polymer molecules and oil polymers. In ropes where there is not enough lubricant i.e. starving ropes, the amplitudes of the peaks are reduced or they may disappear totally. It is thus possible to monitor the lubricant and to produce warnings e.g. of starving ropes based on the system. The wavenumber 4000 to 1000 cm⁻¹ shown on the horizontal axis in the figure corresponds thus to the wavelength 2.5 to 10 μm. The vertical axis shows the absorption.

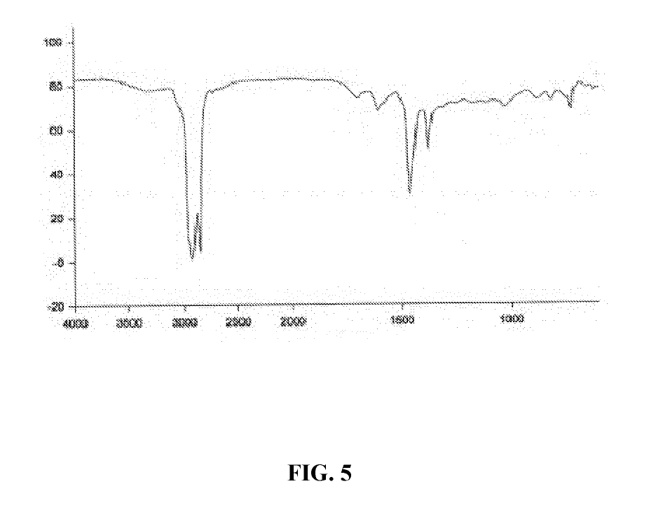

FIG. 5 shows the total spectrum of rope grease. The wavenumber 4000 to 1000 cm⁻¹ shown on the horizontal axis in the figure corresponds thus to the wavelength 2.5 to 10 μm. The vertical axis shows the transmittance in percent. The rope grease contains as main components hydrocarbon based oil and paraffin. There are also impurities in the grease.

It is also possible to add a marker which is sensitive to the electromagnetic radiation transmitted with the transmitter to the lubricant on the rope. The presence of the marker in the lubricant may be detected with the detector 120. The use of the marker in the lubricant would make it easy to identify the lubricant in the analysis and the amount of the lubricant on the rope. The marker should be sensitive only to a narrow wavelength range of the used electromagnetic radiation so that the presence of the marker in the lubricant is easy to detect. The wavelengths of electromagnetic radiation that are absorbed by the marker may be clearly distinct from the wavelengths that are absorbed by the at least one substance on the ropes. This may make it easier to identify the marker in the measured wavelength spectrum.

A marker may also be used in a situation in which the friction between the ropes and the traction sheave are normally too low. The friction between the ropes and the traction sheave may in such a situation be increased by using a suitable lubricant. The lubricant will thus increase the friction between the ropes and the traction sheave. The possibility to use normal lubrication i.e. lubrication that reduces the friction between the ropes and the traction sheave by mistake should thus be eliminated in such a situation. This may be done by adding a marker to the correct lubricant. The use of a false lubricant may thus be detected as the marker is not present in the false lubricant. The system may be configured such that a lack of the marker in the lubricant immediately stops the normal use of the elevator.

Methionine which is an essential amino acid in humans could be used as a marker in the lubricant. Methionine sulfoxide, which is produced as a result of methionine oxidation in protein therapeutics, can be monitored as an increase in peaks in the electromagnetic radiation at wavenumbers 1044 and 1113 cm⁻¹.

An elevator comprises typically 3-9 suspension ropes. The suspension ropes are normally arranged in one or more vertical planes at a certain distance from each other. All the suspension ropes are from the same manufacturing batch and they are running under equal conditions. The outermost suspension ropes are often wearing slightly faster compared to the other suspension ropes. It may therefore be enough to monitor only each of the outermost suspension ropes and maybe the neighbour suspension rope to the outermost suspension rope. It is, however, naturally possible to monitor each of the suspension ropes.

The transmitter 110 and the detector 120 may advantageously be positioned on the same side of the rope 40, but they could also be positioned on opposite sides of the rope 40. The detector 120 may be positioned at an angular distance from the transmitter 110 along the perimeter of the rope 40. The detector 120 and the transmitter 110 may be positioned on the same horizontal level or they may be positioned on different horizontal levels. The detector 120 and the transmitter 110 may be positioned one upon the other when they are positioned at the same angular position in relation to the rope 40.

A laser might also be used as an electromagnetic radiation source in the transmitter 110. The idea would then be to provide energy with the laser to the molecules or chains of molecules in the lubrication so that the laser beam would excite the atoms, molecules or nucleus in the lubrication to an exited state. The atoms, molecules or nucleus in the lubrication will shortly after the excitation return to the base state, whereby electromagnetic radiation is emitted from the lubrication. This electromagnetic radiation can then be measured with the detector.

In quantum mechanics, an excited state of a system, such as an atom, molecule or nucleus, is any quantum state of the system that has a higher energy than the ground state. Excitation is an elevation in energy level above an arbitrary baseline energy state. The lifetime of a system in an excited state is usually short. Spontaneous or induced emission of a quantum of energy occurs shortly after the system is promoted to the excited state, returning the system to a state with lower energy. After excitation the atom may return to the ground state or a lower excited state, by emitting a photon with a characteristic energy. Emission of photons from atoms in various excited states leads to an electromagnetic spectrum showing a series of characteristic emission lines.

The invention can be used to monitor only one rope at a time or to monitor several ropes simultaneously. At least one rope may thus be monitored simultaneously in the invention.

The invention can be used to monitor any rope e.g. suspension ropes for the car, suspension ropes for the counter weight, compensation ropes of the car, over speed governor ropes, and ropes relating to the elevator car doors. The cross section of the rope to be monitored can be of any form e.g. round or flat or rectangular. The invention may be used in connection with uncoated or coated ropes. The coating or shelter of the rope must, however, be such that it does not hinder IR radiation from passing through. The rope may be stranded from individual strands, which in turn consist of individual wires. The round ropes are usually not sheathed, and so the stranding is visible on the surface thereof. The rope may be a steel rope, which means that the wires forming the strands are of steel. There may, however, also be non-metallic wires included in the rope.

The invention can be used in any type of elevator i.e. the use of the invention is not limited to the elevator disclosed in the figures. The elevator may or may not be provided with a machine room. The counterweight could be positioned on either side wall or on both side walls or on the back wall of the elevator shaft. The drive, the motor, the traction sheave, and the machine brake could be positioned in the machine room or somewhere in the elevator shaft. The car guide rails could be positioned on opposite side walls of the shaft or on a back wall of the shaft in a so called ruck-sack elevator.

The arrangement can be mounted permanently in the elevator or the arrangement can be portable and used by a technician when he inspects the ropes of an elevator.

It will be obvious to a person skilled in the art that, as the technology advances, the inventive concept can be implemented in various ways. The invention and its embodiments are not limited to the examples described above but may vary within the scope of the claims.

1. A method for monitoring at least one rope in an elevator, wherein the method comprises:
transmitting electromagnetic radiation towards the rope with a transmitter positioned in the vicinity of the rope;
receiving electromagnetic radiation reflected or emitted from the rope with a detector positioned in the vicinity of the rope;
performing a mathematical transformation of the output signal of the detector with a processing unit for decomposing the output signal into the frequencies that make up the output signal; and
determining the wavelengths of the electromagnetic radiation that have been absorbed by at least one substance on the rope and the amount of the absorption of said wavelengths in order to determine the amount and the content of the substance on the rope.

2. The method according to claim 1, wherein the substance is a lubricant on the rope.

3. The method according to claim 1, wherein the electromagnetic radiation transmitted by the transmitter has a wavelength in the order of 100 nm to 25 μm.

4. The method according to claim 1, wherein the electromagnetic radiation transmitted by the transmitter has a wavelength in the order of 1 μm to 25 μm.

5. The method according to claim 1, wherein the method further comprises:
adding a marker which is sensitive to the electromagnetic radiation transmitted with the transmitter to the lubricant on the rope, whereby the presence of the marker in the lubricant is detected with the detector.

6. An arrangement for monitoring at least one rope in an elevator, wherein the arrangement comprises:
a transmitter positioned in the vicinity of the rope, said transmitter transmitting electromagnetic radiation towards the rope;
a detector positioned in the vicinity of the rope, said detector receiving electromagnetic radiation reflected or emitted from the rope; and
a processor configured to perform a mathematical transformation of the output signal of the detector for decomposing the output signal into the frequencies that make up the output signal,
whereby the wavelengths of the electromagnetic radiation that have been absorbed by at least one substance on the rope and the amount of the absorption of said wavelengths can be determined in order to determine the amount and the content of the substance on the rope.

7. The arrangement according to claim 6, wherein the substance is a lubricant on the rope.

8. The arrangement according to claim 6, wherein the electromagnetic radiation transmitted by the transmitter has a wavelength in the order of 100 nm to 25 μm.

9. The arrangement according to claim 6, wherein the electromagnetic radiation transmitted by the transmitter has a wavelength in the order of 1 μm to 25 μm.

10. An elevator comprising:
at least one rope; and
the arrangement according to claim 6.

11. The method according to claim 2, wherein the electromagnetic radiation transmitted by the transmitter has a wavelength in the order of 100 nm to 25 μm.

12. The method according to claim 2, wherein the electromagnetic radiation transmitted by the transmitter has a wavelength in the order of 1 μm to 25 μm.

13. The method according to claim 3, wherein the electromagnetic radiation transmitted by the transmitter has a wavelength in the order of 1 μm to 25 μm.

14. The method according to claim 2, wherein the method further comprises:
adding a marker which is sensitive to the electromagnetic radiation transmitted with the transmitter to the lubricant on the rope, whereby the presence of the marker in the lubricant is detected with the detector.

15. The method according to claim 3, wherein the method further comprises:
adding a marker which is sensitive to the electromagnetic radiation transmitted with the transmitter to the lubricant on the rope, whereby the presence of the marker in the lubricant is detected with the detector.

16. The method according to claim 4, wherein the method further comprises:
adding a marker which is sensitive to the electromagnetic radiation transmitted with the transmitter to the lubricant on the rope, whereby the presence of the marker in the lubricant is detected with the detector.

17. The arrangement according to claim 7, wherein the electromagnetic radiation transmitted by the transmitter has a wavelength in the order of 100 nm to 25 μm.

18. The arrangement according to claim 7, wherein the electromagnetic radiation transmitted by the transmitter has a wavelength in the order of 1 μm to 25 μm.

19. The arrangement according to claim 8, wherein the electromagnetic radiation transmitted by the transmitter has a wavelength in the order of 1 μm to 25 μm.

20. An elevator comprising:
at least one rope; and
the arrangement according to claim 7.
